(19) United States
(12) Patent Application Publication
(10) Pub. No.: US 2003/0154612 A1
(43) Pub. Date: Aug. 21, 2003

(54) Method for indicating a pouring amount for a pot and volume measuring strip therefor

(76) Inventors: Richard Petri, Montabaur (DE); Dietmar Lange, Vallendar (DE); Peter Schlimm, Montabaur (DE)

Correspondence Address: FULBRIGHT & JAWORSKI, LLP, 1301 MCKINNEY, SUITE 5100, HOUSTON, TX, 77010-3095, US

(21) Appl. No.: 10/257,202

(22) PCT Filed: Apr. 12, 2001
(86) PCT No.: PCT/EP01/04222

(30) Foreign Application Priority Data
Apr. 19, 2000 (DE) 100 19 434.6

(51) Int. Cl. G01D 21/00

(52) U.S. Cl. 33/522

(57) ABSTRACT

The invention relates to a method for indicating the watering quantity suitable for a pot, particularly a flower pot, via the determination of the pot volume V from the pot height H and pot diameter D, as well as to a volume measuring tape or tape measure usable in this method.

The invention relates to a method for indicating the watering quantity suitable for a pot, particularly a flower pot and a volume measuring tape or tape measure usable for the same.

The determination of a pot volume, particularly in the case of a flower pot or the like, is particularly important if it is necessary to estimate how much water is needed or tolerable for a plant placed in said pot. It is particularly important to determine the water quantity for plants which are inserted in clay granulate, e.g. Seramis®. The advantage of such clay granulates is not only their water storage capacity, but also that when the pot volume is known it is possible to determine an optimum watering quantity, which e.g. when using Seramis® is one quarter of the pot volume. If this volume is not completely utilized, there are short watering intervals, so that full advantage is not then taken of the clay granulates. However, overwatering is the most frequent cultivation or care error for plants in clay granulate and in extreme cases can lead to the plant dying.

For the determination of the pot volume it is e.g. possible to estimate, calculate or measure the volume and most users estimate the pot volume empirically, which leads to uncertainty when watering and represents a certain risk for the plants. The calculation or measuring of the pot volume represent very complicated possibilities, which will rarely be employed by a user.

One possible calculation method for the volume of substantially cylindrical pots is provided mathematically by the following equation:

V=π(D/2)²×H

in which V is the volume, D the diameter and H the height of the pot. However, in the case of extremely conical or convex pot shapes, this simple formula leads to significant divergences from the actual pot volume.

If the volume is determined by measurement and is subsequently related to in each case one of the two quantities H and D, the regressions show that the measurement of only one quantity does not lead to an adequately precise volume determination and namely n the following way with a coefficient of determination r² as the measurement quantity how well the equations reproduce the mutual dependence of the quantities:

V=f(D)=0.50×D−5.50r²=0.95 (1)

V=f(H)=0.60×H−5.20r²=0.95 (2)

Thus, there is only a 95% certainty when determining the volume as a function f of the diameter D or the height H.

Thus, the hitherto known methods for determining a pot volume, i.e. estimating, calculating or measuring, are firstly very imprecise and secondly require relatively significant effort and in particular the taking into account of only one parameter “diameter” or “height” during volume determination leads to very imprecise results.

The problem of the present invention is to provide a method for indicating the watering quantity suitable for a pot, particularly a flower pot, which can be rapidly and easily performed. A further problem of the invention is to make available a means by which this method can be easily performed by a user.

According to the invention the method problem is solved by a method for indicating the watering quantity suitable for a pot, particularly a flower pot, via the determination of the pot volume from the sum of the pot height H and pot diameter D.

According to the invention, the method is characterized in that the diameter D is determined in the vicinity of the pot opening and preferably account is taken of a correction factor for the pot rim and/or conical pot shapes.

The method according to the invention is also characterized in that V=0.29 (D+H)−5.71 and preferably V is reduced by 10% for a conical pot shape.

The invention also proposes that the watering quantity G is proportional to the volume, with G=K×V, the proportionality factor K being selected as a function of a pot filling, such as clay granulate or the like, particularly K=¼ in the case of Seramis®.

The problem according to the invention is also solved by a volume measuring tape or tape measure with at least one scale for reading off the pot volume and/or the watering quantity for the pot, determined in a method according to one of the preceding claims.

The invention is then characterized in that a first scale on the volume measuring tape is subdivided into length units, e.g. centimeters, and/or a second scale on the volume measuring tape into volume units, e.g. milliliters.

According to the invention, a third scale takes account of a correction factor for the pot rim.

A further development of the invention is characterized in that a fourth scale takes account of a correction factor for conical pot shapes.

Preferably the first, third and/or fourth scale are combined into one and/or the second, third and/or fourth scale are combined into one.

The invention is also characterized in that the volume measuring tape is bendable and/or flexible in order to be applicable to the pot, preferably covering a very short connection between two diametrically facing rim points, whereof one is located in the bottom part and the other in the rim of the pot opening.

Preferably, according to the invention, the volume measuring tape is made from paper, textile fabric, plastic or metal.

The invention finally proposes that the volume measuring tape can be rolled up and preferably for reading off the at least one scale it can at least partly by unrolled by the application of a first force and automatically rolls up by the application of a second force.

Therefore the invention is based on the surprising finding that with the aid of the method according to the invention it is possible to determine a suitable watering quantity for a pot in very precise manner, but using simple means. On taking account of the sum of the diameter D and the height H, the pot volume V can be calculated according to the following equation:

V=f(ΣD,H)=0.29×(D+H)−5.71

in which r²=0.99 (3)

Thus, the connection between the pot volume and the sum of its diameter and height can be almost 100% explained. The correct watering quantity results from the volume determined by mans of equation (3), in that account is taken of a factor for a corresponding clay granulate. If e.g. in the case of Seramis® the watering quantity is one quarter of the pot volume, the equation (3) must be multiplied by the factor 0.25 for determining the watering quantity.

Further features and advantages of the invention can be gathered from the following description of an embodiment of the invention relative to the diagrammatic drawings and graphs, wherein show:

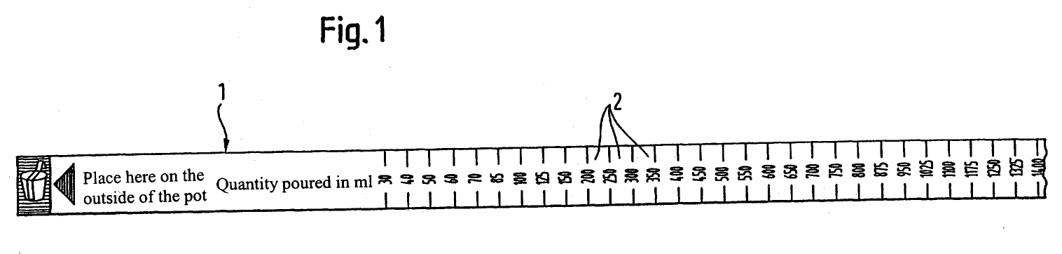

FIG. 1A portion of a volume measuring tape according to the invention on a reduced scale.

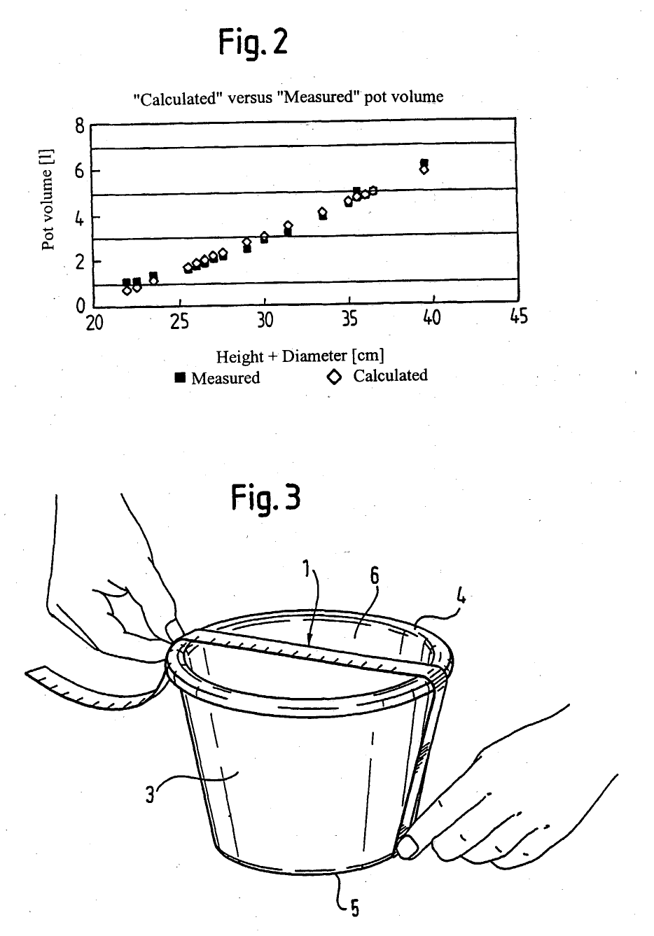

FIG. 2A graph of the pot volume as a function of the sum of the pot height V and pot diameter D after measuring and calculating according to equation (3).

FIG. 3A representation for illustrating the application of a volume measuring tape according to the invention to a pot.

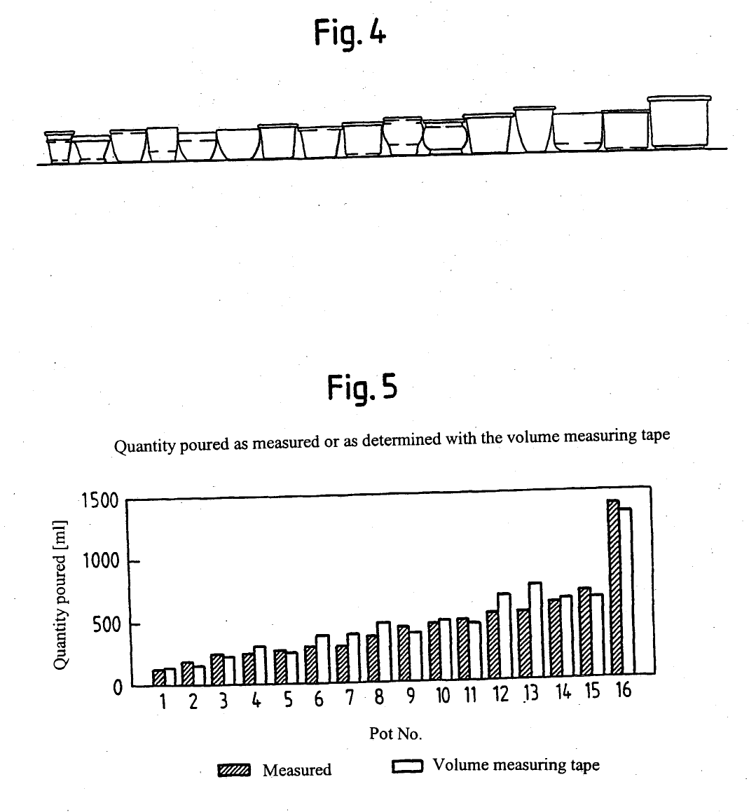

FIG. 4 16 pots.

FIG. 5A graph relating to the watering quantities for the 16 pots of FIG. 4, determining both by measurement and with the aid of the volume measuring tap according to the invention.

FIG. 1 shows a volume measuring tape 1 according to the invention with a scale 2. By means of scale 2 it is possible to directly read from the volume measuring tape 1 a suitable watering quantity for a specific pot in milliliters, as will be described hereinafter. The scale 2 of the volume measuring tape 1 can be derived via the connection in the above equation (3), whilst taking account of pot rim.

It is also possible to have a scale in length units, e.g. in centimeters, and to correlate these values with table values for a corresponding volume.

FIG. 2 shows for different pots the pot volume V as a function of the particular pot height and particular pot diameter D, accompanied by the plotting on the one hand of values determined by measuring out the particular pot and on the other values determined in accordance with equation (3). As can be clearly gathered from FIG. 2, there is a very good coincidence between the values determined by measuring and the calculated values for each pot.

FIG. 3 illustrates an application of the volume measuring tape 1 according to the invention to a pot 3. The pot 3 comprises a bottom part 5, a pot rim 4 and a pot opening 6. The volume measuring tape 1 is applied to the pot 3 in such a way that the sum of the height H and diameter D of the pot 3 can simultaneously be measured with a single measurement. The volume measuring tape 1 covers the shortest connection between two diametrically facing rim points of the pot 3, namely a point in the bottom part 5 of the pot 3 to a point in the rim around the pot opening 6.

For checking the accuracy of the volume measuring tape 1 according to the invention, it was checked on 16 pots 3 of different sizes and shapes, which are shown in FIG. 4. As can be gathered from FIG. 5, the volume of virtually all of the 16 pots or the watering quantity resulting from the volume as a function of the pot filling, can be accurately determined by mans of the volume measuring tape 1 according to the invention compared with determination by measurement. Only in the case of conically tapering pots, such as 12 and 13, do inaccuracies occur, but they can be compensated by taking account of a correction factor. It is also possible to take account of a correction factor for the pot rim 4.

In summarizing, as a result of the volume measuring tape 1 according to the invention the volume of a pot can be determined with simple means. The volume measuring tape 1 according to the invention is particularly suitable for determining the correct watering quantity for plants, placed in a flower pot with clay granulate.

The features of the invention disclosed in the description, drawings and claims can be essential to the implementation of the different embodiments of the invention, either singly or in random combination.

1. Method for indicating the watering quantity suitable for a pot, particularly a flower pot, via the determination of the pot volume V from the sum of the pot height H and pot diameter D.

2. Method according to claim 1, characterized in that the diameter D is determined in the area of the pot opening and account is preferably taken of a correction factor for the pot rim and/or conical pot shapes.

3. Method according to claim 1 or 2, characterized in that V=0.29(D+H)−5.71 and preferably V is reduced by 10% for conical pot shapes.

4. Method according to one of the preceding claims, characterized in that the watering quantity G is proportional to the volume, with G=K×V, the proportionality factor K being selected as a function of a pot filling, such as a clay granulate or the like and in particular K=¼ in the case of Seramis®.

5. Volume measuring tape (1) with at least one scale (2) for reading off the volume of a pot (3) and/or the watering quantity for the pot (3), determined in a method according to one of the preceding claims.

6. Volume measuring tape according to claim 5, characterized in that a first scale (2) on the volume measuring tape (1) is subdivided into length units, e.g. centimeters, and/or a second scale on the volume measuring tape (1) is subdivided into volume units, e.g. milliliters.

7. Volume measuring tape according to claim 5 or 6, characterized in that a third scale (2) takes account of a correction factor for the pot rim (4).

8. Volume measuring tape according to one of the claims 5 to 7, characterized in that a fourth scale (2) takes account of a correction factor for conical pot shapes.

9. Volume measuring tape according to claim 7 or 8, characterized in that the first, third and/or fourth scale (2) are combined into one and/or the second, third and/or fourth scale (2) are combined into one.

10. Volume measuring tape according to one of the clams 5 to 9, characterized in that the volume measuring tape (1) is bendable and/or flexible to be applicable to the pot (3), preferably covering the shortest connection between two diametrically facing rim points, whereof one is located in the bottom part (5) and the other in the rim (4) around the opening (6) of the pot (3).

11. Volume measuring tape according to one of the claims 5 to 10, characterized in that the volume measuring tape (1) is made from paper, textile fabric, plastic or metal.

12. Volume measuring tape according to one of the claims 5 to 11, characterized in that the volume measuring tape (1) can be rolled up and preferably for reading off the at least one scale (2) can at least partly be unrolled by applying a first force and automatically rolls up by applying a second force.
